(19) United States
(12) Patent Application Publication
(10) Pub. No.: US 2001/0055679 A1
(43) Pub. Date: Dec. 27, 2001

(54) Adhesive tape, in particular for masking a cathodic electrocoat primer

(76) Inventors: Uwe Schumann, Pinneberg (DE); Nicolai Bohm, Hamburg (DE); Siegfried Krupke, Tornesch (DE); Ulrike Wappler, Hamburg (DE)

Correspondence Address: Norris McLaughlin & Marcus, P.A., 660 White Plains Road, Tarrytown, NY, 10591-5144, US

(21) Appl. No.: 09/736,548

(22) Filed: Dec. 13, 2000

(30) Foreign Application Priority Data
Dec. 15, 1999 (DE) 199 60 466.5

(51) Int. Cl. B32B 7/12; B32B 15/04

(52) U.S. Cl. 428/352; 428/343; 428/355 EP; 428/355 AC

(57) ABSTRACT

An adhesive tape provided on one side with a self-adhesive composition and comprising a backing material comprising a polyester film coated with a crosslinked epoxy resin.

The invention relates to an adhesive tape, especially for masking off window flanges, preferably in automotive body shells coated with cathodic electrocoat, and to processes for producing the adhesive tape. The purpose of the adhesive tape is to protect the window flanges against overpainting during the subsequent coating and baking processes such that following the removal of the adhesive tape an automotive glass window can be installed onto the surfacer-and topcoat-free window flange using a reactive PU window adhesive.

Automobile glass windows are conventionally mounted in the painted vehicle body using rubber seals. In recent years, this method has been increasingly replaced by the installation of the windows using reactive adhesives (based, for example, on polyurethane). The window is coated with the adhesive and placed on the body such that the adhesive bead is pressed onto the window flange.

The installed windows, especially the windshields, nowadays act as reinforcing elements of the body. In the extreme case, that of the vehicle turning over, they prevent the roof columns from buckling. Consequently, a sufficient bond strength is critical to the safety of a modern motor vehicle in an accident situation.

Modern automotive finishes comprise a variety of coats, which are applied to the primed bodywork metal in the following order (schematically):

electrophoretic coat, usually cathodic electrocoat

surfacer or functional coat

color coat

topcoat According to Römpp Lexikon Chemie (Version 1.5, Stuttgart/New York: Georg Thieme Verlag 1998), electrophoretic coating (electrodeposition coating; electrocoating) is a technique in which coating takes place by the action of an electrical field (from 50 to 400 V). The article to be coated, which conducts electric current, is introduced into the paint bath as an anode or cathode, with the tank wall in practice acting as the second electrode. The amount of paint deposited is directly proportional to the amount of current supplied. Electrophoretic coating is used especially for priming, in the automotive industry, for example. There are no spray losses, and the coatings obtained are highly uniform, even in difficult-to-reach areas. Where the substrates are not conductive, such as plastics, glass, ceramic, etc., coating is carried out by way of the electrostatic charging of the paint particles (known as electrostatic coating).

If the automobile window is bonded onto the painted window flange after the painting process has been completed, the following disadvantages arise. Since the window adhesive has to be matched to the topcoat as its adhesion substrate, an unnecessarily high degree of complexity may result given the large number of topcoats used by a manufacturer, since it is necessary to hold a large number of appropriate adhesives in stock. More significant, however, is the fact that the total bond strength of the automobile window depends on the weakest point in the multicoat paint system, and may therefore be much lower than the bond strength of the adhesive to the topcoat.

It is therefore advantageous to apply the window to the bottommost paint coat, the cathodic electrocoat. The number of cathodic electrocoat preparations used by a manufacturer is usually lower than the number of topcoats. Firstly, there are few defined adhesion substrates for the window adhesive, and secondly the system comprising primed metal/cathodic electrocoat/window adhesive, with two boundary layers, harbors a lower risk of fracture than a complex overall coating system.

To mask the window flange following the application of the cathodic electrocoat it is possible to use a PVC plastisol as described in EP 0 655 989 B1. This plastisol is applied in liquid form to the window flange, painted over and gelled during the baking phase at temperatures of at least 163° C. to give a solid film. A disadvantage of this process is that for the purpose of demasking after baking has taken place it is necessary for a “grip tab” to be mechanically exposed, in which case the cathodic electrocoat may also easily be damaged, something which harbors the danger of subsequent corrosion.

On the window flanges, the plastisol strip crosses, in some cases more than once, PVC seam sealants which fill weld seams. On gelling, a frequent observation is of instances of severe sticking between seam sealants and PVC plastisol window flange masking, which prevent easy demasking. Another observation is of plastisol-related contamination of the adhesion substrate, giving rise to an adhesion failure at the boundary between window adhesive and formerly plastisol-masked cathodic electrocoat.

As a result, the required bonding security of the window is not ensured. Although this drawback can be countered by using a primer, such a step is labor-intensive, leads to unwanted solvent emissions, and may necessitate repair to the paint, as a result of accidental splashing or dripping on the topcoat.

A more advantageous possibility for the masking of window flanges is the use of adhesive tapes. For a number of years, masking has been carried out using a PVC-polyester laminate, laminated with natural rubber adhesive and rendered self-adhesive with a natural rubber adhesive composition. Similarly to the plastisol bead, this adhesive tape is bonded to the cathodically electrocoated window flange before surfacing and coating, and following baking is removed together with the paint coats applied to it. Application may be done by hand or else, in an automated process, by robot.

The principal disadvantage of this last-mentioned product is the frequency of errors during demasking, since the laminate tends toward complete and partial splicing and also toward tearing. Partial splicing, in particular, represents a safety risk, since the polyester film which remains on the window flange is little different in color from the cathodic electrocoat and is therefore easily missed. These residues of polyester are a wholly inappropriate adhesion medium for window adhesives and, accordingly, may result in inadequate window adhesion.

A further disadvantage both of the last-mentioned product and of the PVC plastisol are the disposal difficulties. Land filling is injudicious for reasons of the biological persistence of the PVC. Recycling is not possible, owing to contamination with the various paint coats. Incineration harbors the hazard of the emission of hydrochloric acid and dioxins. To avoid this requires complex measures in the incinerators, such as flue-gas scrubbing and very high incineration temperatures, for example.

It is an object of the invention to develop an adhesive tape, especially for window flange masking, with a backing material which does not exhibit the disadvantages of the prior art, or not to the same extent. In particular, on demasking, the adhesive tape should neither tear nor undergo complete or partial splicing. Moreover, the adhesive tape should not contain PVC.

This object is achieved by means of an adhesive tape as specified in the main claim. The subclaims relate to advantageous developments of the adhesive tape, uses and processes for the production thereof.

Suitable backing materials, in principle, for an adhesive tape which for this application is required to withstand typical high temperatures of up to 180° C. for approximately 30 minutes are films made of polyester (polyethylene terephthalate PET, polyethylene naphthalate PEN), and also fibrous materials such as cotton, aromatic polyamide and polyester wovens or nonwovens. A disadvantage of fiber materials is their inherent low extensibility, which makes it more difficult to stick the tape on in curves.

If the tape is to be processed by robot, it is subjected to strong tensile forces and must therefore possess a high tensile modulus in order to prevent early extension, which under the hot conditions leads to a high recovery tension.

The requirement for high tensile strength in combination with temperature resistance for a number of minutes is met by biaxially oriented PET or PEN films having a draw ratio lengthwise (MD: machine direction) to crosswise (CD: cross direction) of from about 3-4:3-4. A problem of oriented polyester films, however, is the low tear propagation resistance as soon as the film edge has suffered minimal damage. Since, when the overpainted adhesive tape is removed, the multicoat paint film is torn and always has a slightly jagged edge, when a simple polyester film is removed the adhesive tape is very frequently torn.

Moreover, simple polyester films are a poor adhesion substrate for applied paint films. The consequence is splintering of surfacer and topcoat and thus contamination of the vehicle surface, especially the window flange joint.

A polyester film coated with a crosslinked epoxy resin as backing material for an adhesive tape proves to be outstandingly suitable for solving the problems posed.

In one possible embodiment, the crosslinked epoxy resin layer comprises further formulation constituents, such as fillers, plasticizers, and auxiliaries and additives, for example. The fillers used may be both reinforcing fillers, such as carbon black, for example, and nonreinforcing fillers, such as chalk or barium sulfate, for example. Further examples are talc, mica, silica, silicates, calcium oxide or zinc oxide. Mixtures of said substances may also be used. Examples of plasticizers are phthalates or alkylsulfonic esters of phenol.

The crosslinked epoxy resin must be such that—as already stated—it withstands the typical high temperatures in this sector of up to 180° C. for approximately 30 minutes and neither before nor after temperature exposure is so brittle and hard that it fractures on bending or folding. In one possible embodiment, customary antioxidants which retard the thermal oxidation of the crosslinked epoxy resin are added to it, at levels in the range between 0% by weight and 5% by weight, along with known light stabilizers, in the range between 0% by weight and 5% by weight. Examples of antioxidants are sterically hindered phenols and secondary aromatic amines. Examples of light stabilizers are derivatives of benzophenone, and sterically hindered amines.

In a preferred embodiment, liquid, solvent-free epoxy resins based on bisphenol A are used to prepare the crosslinked epoxy resin layer. Also suitable, however, are epoxy resins based on bisphenol F or bisphenol A/F, reactively diluted or plasticized epoxy resins, polyfunctional novolak glycidyl ether resins, aliphatic or cycloaliphatic epoxy resins and mixtures of said epoxy resins. In another preferred embodiment, formulated polyethers/polyamines are used as curing agents for the epoxy resins. Also suitable, however, are nonformulated aliphatic polyamines, araliphatic polyamines, cycloaliphatic polyamines, aromatic amine curing agents, modified polyamines, polyamidoamines, polyaminoimidazoline, polyether amines, formulated adducts and mixtures of said amines.

In addition to the listed epoxy resin components and the hardening components which react with them, however, it is also possible to use other starting materials to form the epoxy resin layer without departing from the concept of the invention.

Crosslinked epoxy resins as described above are prior art in their preparation and are described, for example, in “Ullmann's Encyclopedia of Industrial Chemistry, Vol. A 9:Epoxides”.

In one preferred embodiment, the polyester film is coated with the crosslinked epoxy resin by the process described below:

a) A vessel A is charged essentially with the epoxy resin component and a vessel B essentially with the curing component, the further formulating constituents having if appropriate been admixed with these components beforehand in a customary mixing process.

b) The epoxy resin component and the curing component are mixed in a mixer of a two-component mixing and metering unit.

c) The epoxy resin/curing agent composition thus mixed is applied to the polyester film which has been coated with a pressure-sensitive adhesive composition and which is preferably moving at a constant speed, the side bearing the pressure-sensitive adhesive composition having been placed on an antiadhesively treated medium, for example, release paper or release film, or an antiadhesively treated belt.

d) The assembly of epoxy resin/curing agent composition, polyester film and pressure-sensitive adhesive composition is passed through a heating tunnel in which the epoxy resin/curing agent composition cures.

e) The laminate, finally, is wound up in a winding station.

In a preparation step, the polyester film is provided on one side with a pressure-sensitive adhesive composition. This is done in a customary coating process, either from a solution or from the melt.

In an alternative process, the polyester film may also be coated first with the crosslinked epoxy resin and then provided with a pressure-sensitive adhesive composition.

Surprisingly, and in a manner unforeseeable to the skilled worker, the assembly of crosslinked epoxy resin and polyester film is found after baking of the paint films to be substantially stronger and more stable than a PVC/polyester assembly, so that on demasking there is no tearing or splicing of the backing material.

It is be regarded as a further advantage that the preparation of the crosslinked epoxy resin/polyester assembly, unlike that of the PVC/polyester assembly, does not require a laminating adhesive. Moreover, the material may be disposed of in a very advantageous way.

Suitable self-adhesive compositions for the adhesive tape are in principle all pressure-sensitive adhesive compositions which have the required temperature stability over approximately 30 minutes at 180° C. and which at these temperatures possess a sufficiently high shear strength to withstand the shrinkage tendency of the backing material. Examples include all crosslinkable natural rubber, synthetic rubber and acrylate adhesive compositions possessing a bond strength appropriate to the application—i.e., more than 2 N/cm—on cathodic electrocoat substrates.

One advantageous embodiment of the self-adhesive composition is based on a copolymer of ethylene, vinyl acetate, acrylic ester, and, if desired, acrylamide. Such a copolymer is described in EP 0 017 986 A1.

Surprisingly, and in a manner unforeseeable for the skilled worker, synthetic rubbers of this kind, based on the monomers ethylene (E), vinyl acetate (VA), acrylic esters (Ac) and acrylamides (Acam), as marketed, for example, by Air Products Polymers, Burghausen, Germany as dispersions, prove to be a suitable adhesive composition for this application.

In one preferred embodiment, the self-adhesive composition has the following makeup:

| | |
|---|---|
| ethylene | from 10 to 30, with particular preference from 10 to 15% |
| | by weight |
| vinyl acetate | from 20 to 55, with particular preference from 30 to 35% |
| | by weight |
| acrylic ester | from 30 to 69, with particular preference from 50 to 60% |
| | by weight |
| acrylamide | from 0 to 8, with particular preference 0.5% by weight. |

The self-adhesive composition may be applied to the backing in dissolved or dispersion form, so that thermal drying results in an adhesive film having a thickness of preferably from 15 to 40 μm.

Depending on the affinity of the adhesive composition for the underside of the backing, a primer may be chosen to ensure secure anchoring of the composition.

With further advantage, a release coating may be present on the reverse of the backing material for the purpose of easy unrollability, and specifically is present when the composition adheres well to the reverse. The release coating is particularly advisable if the material is to be wound into a roll without a separating medium. At the same time, it must ensure secure surfacer and paint adhesion.

The advantages of the adhesive tape of the invention are manifested in particular when it is used in automotive construction. In the text below, this application is described in detail, though is selected only by way of an example of similar applications.

Following the body electrocoating process, in which the cathodic electrocoat is applied to the primed body shell, and following the baking of the cathodic electrocoat, in which the reactive fresh cathodic electrocoat is crosslinked by heat exposure, the adhesive tape with the backing of a polyester film coated with a crosslinked epoxy resin, is bonded to the window flange in a width of preferably from 10 to 25 mm.

In the course of this application, the tape must be stretched around the curves, so that no spray mist from the subsequent coating steps is able to pass below any folds. The tape remains on the body until all of the coating steps have been completed. After the body has been cooled, the tape can then be removed, together with the paint coats adhering to it, without tearing, delamination and leaving residues of adhesive tape. The cathodic electrocoat track that remains after demasking offers a secure adhesion substrate for the bonding of automobile windows with the aid of water-sensitive, polyurethane-based reactive adhesives.

The adhesive tape of the invention is described below in a preferred embodiment with reference to a number of examples, without thereby wishing to restrict the invention in any way. Moreover, comparative examples are given, in which unsuitable adhesive tapes are depicted.

The following test methods were used to briefly characterize the samples produced in accordance with the described process:

The bond strength was determined in accordance with BDF JOPMA002.

According to this method, the adhesive tape specimen for testing was applied to the adhesion substrate (steel) and then peeled off under defined conditions in a tensile testing machine. The peel angle was 180° in each case, the peel rate 300 mm/min. The force required for peeling is the bond strength.

The tensile strength and elongation at break were determined in the tensile test according to BDF JOPMC001.

In this case, a test strip 100 mm long and 19 mm wide was stretched in the longitudinal direction in a tensile testing machine at a defined clamp speed (300 mm/min) until it tore. The tensile strength, based on the width measurement of the sample, and the elongation for the tear force were determined.

Coating in the examples was carried out on an installation from the company Pagendarm. The web width was 50 cm. The width of the coating gap was variably adjustable between 0 and 1 cm. The length of the heating tunnel was approximately 12 m. The temperature in the heating tunnel was divisible into four zones and in each case selectable freely between room temperature and 120°C.

A two-component mixing and metering unit from the company Spritztechnik-EMC was used. The mixing system was dynamic. The mixing head was designed for two liquid components. The mixing rotor had a variable speed with a maximum of approximately 5000 rpm. The metering pumps of this unit were toothed gear pumps having a maximum output of approximately 2 l/min.

In those cases where formulations were concerned, the epoxy resin components were prepared in an evacuable dissolver from Molteni.

### EXAMPLES

### Example 1

In a customary coating process, a 23 μm thick polyester (polyethylene terephthalate) film was coated with an application thickness of approximately 25 μm from a solution with a known pressure-sensitive adhesive composition based on natural rubber and comprising

| | |
|---|---|
| 48% | natural rubber CV50 |
| 23% | poly-beta-pinene resin |
| 5% | terpene-phenolic resin |
| 3% | rosin |
| 7% | acrylonitrile-butadiene copolymer |
| 8% | zinc oxide |
| 5% | reactive alkylphenol resin and |
| 1% | 2,5-di(tertiary-amyl)hydroquinone |

and on winding was lined with a standard commercial release paper.

The polyester film provided with the pressure-sensitive adhesive composition was coated from the nonadhesive side with a degassed, two-component epoxy resin/curing agent composition at a rate of 1 m/min. The application thickness was 120 μm. Curing took place at a tunnel temperature of 120°C.

The epoxy resin/curing agent composition was made up as follows:

| | | Weight fraction |
|---|---|---|
| | Raw material | [% by wt.] |
| A component | Araldite GY 240 ® | 41.9 |
| B component | Euredur 76 ® | 58.1 |

The resulting adhesive tape had a tensile strength of 89.8 N/cm with an elongation at break of 76.4%. The bond strength on steel was 4.4 N/cm.

A metal test panel was coated electrophoretically with the cathodic electrocoat Cathoguard 400 from BASF and baked at 175° C. for 20 minutes. The adhesive tape was bonded to the test panels without bubbles in a width of 20 mm and a length of 30 cm in the shape of an S curve, and pressed on firmly. The fold-free bonding on the curves required a high level of force to be exerted in order to stretch the film. Subsequently, in accordance with hard practical conditions, the bonded panel was coated with a surfacer, which was baked at 180° C. for 30 minutes. After cooling, a solventborne basecoat film was applied, which was flashed off at room temperature for 5 minutes and then covered with a 2-component clearcoat. The panel was subsequently dried in an oven at 130° C. for 30 minutes.

Visual assessment after cooling showed the tape to be unchanged in position relative to the original position. Subsequently, the tape was removed at various peel angles between 45° and 180°. It was possible to remove the adhesive tape from the cathodically electrocoated panel without problems, with no tearing or delamination. A clean, paint-free track remained on the cathodic electrocoat substrate. The paint remained adhering fully to the reverse of the tape.

### Example 2

In a customary coating process, a 23 μm thick polyester (polyethylene terephthalate) film was coated with an application thickness of approximately 25 μm from a solution with the natural-rubber-based pressure-sensitive adhesive composition specified in Example 1 and on winding was lined with a standard commercial release paper.

The polyester film provided with the pressure-sensitive adhesive composition was coated from the nonadhesive side with a degassed, two-component epoxy resin/curing agent composition at a rate of 1 m/min. The application thickness was 120 μm. Curing took place at a tunnel temperature of 120° C.

The epoxy resin/curing agent composition was made up as follows:

| | | Weight fraction |
|---|---|---|
| | Raw material | [% by wt.] |
| A component | Araldite GY 240 ® | 33.1 |
| | Omyacarb 4BG ® | 20.0 |
| B component | Euredur 76 ® | 45.9 |

The resulting adhesive tape had a tensile strength of 81.5 N/cm with an elongation at break of 66.4%. The bond strength on steel was 3.8 N/cm.

A metal test panel was coated electrophoretically with the cathodic electrocoat Cathoguard 400 from BASF and baked at 175° C. for 20 minutes. The adhesive tape was bonded to the test panels without bubbles in a width of 20 mm and a length of 30 cm in the shape of an S curve, and pressed on firmly. The fold-free bonding on the curves required a high level of force to be exerted in order to stretch the film. Subsequently, in accordance with hard practical conditions, the bonded panel was coated with a surfacer, which was baked at 180° C. for 30 minutes. After cooling, a solventborne basecoat film was applied, which was flashed off at room temperature for 5 minutes and then covered with a 2-component clearcoat. The panel was subsequently dried in an oven at 130° C. for 30 minutes.

Visual assessment after cooling showed the tape to be unchanged in position relative to the original position. Subsequently, the tape was removed at various peel angles between 45° and 180°. It was possible to remove the adhesive tape from the cathodically electrocoated panel without problems, with no tearing or delamination. A clean, paint-free track remained on the cathodic electrocoat substrate. The paint remained adhering fully to the reverse of the tape.

### Example 3

A 23 μm thick polyester (polyethylene terephthalate) film was coated with a degassed, two-component epoxy resin/curing agent composition at a rate of 1 m/min and on winding was lined with a standard commercial release paper.

The application thickness was 120 μm. Curing took place at tunnel temperature of 120° C.

The epoxy resin/curing agent composition was made up as follows:

| | | Weight fraction |
|---|---|---|
| | Raw material | [% by wt.] |
| A component | Araldite GY 240 ® | 33.1 |
| | Omyacarb 4BG ® | 20.0 |
| B component | Euredur 76 ® | 45.9 |

Subsequently, the polyester film provided with the crosslinked epoxy resin was coated in a customary process with an application thickness of approximately 25 μm from a solution with the natural-rubber-based pressure-sensitive adhesive composition specified in Example 1.

The resulting adhesive tape had a tensile strength of 83.2 N/cm with an elongation at break of 71.6%. The bond strength on steel was 3.4 N/cm.

A metal test panel was coated electrophoretically with the cathodic electrocoat Cathoguard 400 from BASF and baked at 175° C. for 20 minutes. The adhesive tape was bonded to the test panels without bubbles in a width of 20 mm and a length of 30 cm in the shape of an S curve, and pressed on firmly. The fold-free bonding on the curves required a high level of force to be exerted in order to stretch the film. Subsequently, in accordance with hard practical conditions, the bonded panel was coated with a surfacer, which was baked at 180° C. for 30 minutes. After cooling, a solventborne basecoat film was applied, which was flashed off at room temperature for 5 minutes and then covered with a 2-component clearcoat. The panel was subsequently dried in an oven at 130° C. for 30 minutes.

Visual assessment after cooling showed the tape to be unchanged in position relative to the original position. Subsequently, the tape was removed at various peel angles between 45° and 180°. It was possible to remove the adhesive tape from the cathodically electrocoated panel without problems, with no tearing or delamination. A clean, paint-free track remained on the cathodic electrocoat substrate. The paint remained adhering fully to the reverse of the tape.

### Example 4

In a customary coating process, a 23 μm thick polyester (polyethylene terephthalate) film was coated with an application thickness of approximately 25 μm with a solvent-based acrylate pressure-sensitive adhesive composition, comprising butyl acrylate (47.5%), ethylhexyl acrylate (47.5%), glycidyl methacrylate (2%), acrylic acid (3%) and small amounts of a known crosslinker, and on winding was lined with a standard commercial release paper.

The polyester film provided with the pressure-sensitive adhesive composition was coated from the nonadhesive side with a degassed, two-component epoxy resin/curing agent composition at a rate of 1 m/min. The application thickness was 120 μm. Curing took place at a tunnel temperature of 120° C.

The epoxy resin/curing agent composition was made up as follows:

| | | Weight fraction |
|---|---|---|
| | Raw material | [% by wt.] |
| A component | Araldite GY 240 ® | 33.1 |
| | Omyacarb 4BG ® | 20.0 |
| B component | Euredur 76 ® | 45.9 |

The resulting adhesive tape had a tensile strength of 87.6 N/cm with an elongation at break of 81.3%. The bond strength on steel was 2.8 N/cm.

A metal test panel was coated electrophoretically with the cathodic electrocoat Cathoguard 400 from BASF and baked at 175° C. for 20 minutes. The adhesive tape was bonded to the test panels without bubbles in a width of 20 mm and a length of 30 cm in the shape of an S curve, and pressed on firmly. The fold-free bonding on the curves required a high level of force to be exerted in order to stretch the film. Subsequently, in accordance with hard practical conditions, the bonded panel was coated with a surfacer, which was baked at 180° C. for 30 minutes. After cooling, a solventborne basecoat film was applied, which was flashed off at room temperature for 5 minutes and then covered with a 2-component clearcoat. The panel was subsequently dried in an oven at 130° C. for 30 minutes.

Visual assessment after cooling showed the tape to be unchanged in position relative to the original position. Subsequently, the tape was removed at various peel angles between 45° and 180°. It was possible to remove the adhesive tape from the cathodically electrocoated panel without problems, with no tearing or delamination. A clean, paint-free track remained on the cathodic electrocoat substrate. The paint remained adhering fully to the reverse of the tape.

### Example 5

In a customary coating process, a 23 μm thick polyester (polyethylene terephthalate) film was coated with an application thickness of approximately 25 μm with Vinnapas EAF 60 (Air Products Polymers, Burghausen, Germany), and on winding was lined with a standard commercial release paper.

The polyester film provided with the pressure-sensitive adhesive composition was processed further as in Example 4. The resulting adhesive tape had a tensile strength of 88.5 N/cm with an elongation at break of 72.8%. The bond strength on steel was 3.1 N/cm.

A metal test panel was coated electrophoretically with the cathodic electrocoat Cathoguard 400 from BASF and baked at 175° C. for 20 minutes. The adhesive tape was bonded to the test panels without bubbles in a width of 20 mm and a length of 30 cm in the shape of an S curve, and pressed on firmly. The fold-free bonding on the curves required a high level of force to be exerted in order to stretch the film. Subsequently, in accordance with hard practical conditions, the bonded panel was coated with a surfacer, which was baked at 180° C. for 30 minutes. After cooling, a solventborne basecoat film was applied, which was flashed off at room temperature for 5 minutes and then covered with a 2-component clearcoat. The panel was subsequently dried in an oven at 130° C. for 30 minutes.

Visual assessment after cooling showed the tape to be unchanged in position relative to the original position. Subsequently, the tape was removed at various peel angles between 45° and 180°. It was possible to remove the adhesive tape from the cathodically electrocoated panel without problems, with no tearing or delamination. A clean, paint-free track remained on the cathodic electrocoat substrate. The paint remained adhering fully to the reverse of the tape.

### Example 6

In a customary coating process, a 23 μm thick polyester (polyethylene terephthalate) film was coated with an application thickness of approximately 25 μm from a solution with the natural-rubber-based pressure-sensitive adhesive composition specified in Example 1, and on winding was lined with a standard commercial release paper.

The polyester film provided with the pressure-sensitive adhesive composition was coated from the nonadhesive side with a degassed, two-component epoxy resin/curing agent composition at a rate of 1 m/min. The application thickness was 120 μm. Curing took place at a tunnel temperature of 120° C.

The epoxy resin/curing agent composition was made up as follows:

| | | Weight fraction |
|---|---|---|
| | Raw material | [% by wt.] |
| A component | Araldite GY 240 ® | 33.1 |
| | Omyacarb 4BG ® | 10.0 |
| B component | Euredur 76 ® | 45.9 |

The resulting adhesive tape had a tensile strength of 69.2 N/cm with an elongation at break of 88.7%. The bond strength on steel was 4.0 N/cm.

A metal test panel was coated electrophoretically with the cathodic electrocoat Cathoguard 400 from BASF and baked at 175° C. for 20 minutes. The adhesive tape was bonded to the test panels without bubbles in a width of 20 mm and a length of 30 cm in the shape of an S curve, and pressed on firmly. The fold-free bonding on the curves required a high level of force to be exerted in order to stretch the film. Subsequently, in accordance with hard practical conditions, the bonded panel was coated with a surfacer, which was baked at 180° C. for 30 minutes. After cooling, a solventborne basecoat film was applied, which was flashed off at room temperature for 5 minutes and then covered with a 2-component clearcoat. The panel was subsequently dried in an oven at 130° C. for 30 minutes.

Visual assessment after cooling showed the tape to be unchanged in position relative to the original position. Subsequently, the tape was removed at various peel angles between 45° and 180°. It was possible to remove the adhesive tape from the cathodically electrocoated panel without problems, with no tearing or delamination. A clean, paint-free track remained on the cathodic electrocoat substrate. The paint remained adhering fully to the reverse of the tape.

### Example 7

In a customary coating process, a 23 μm thick polyester (polyethylene terephthalate) film was coated with an application thickness of approximately 25 μm from a solution with the natural-rubber-based pressure-sensitive adhesive composition specified in Example 1, and on winding was lined with a standard commercial release paper

The polyester film provided with the pressure-sensitive adhesive composition was coated from the nonadhesive side with a degassed, two-component epoxy resin/curing agent composition at a rate of 1 m/min. The application thickness was 120 μm. Curing took place at a tunnel temperature of 120° C.

The epoxy resin/curing agent composition was made up as follows:

| | | Weight fraction |
|---|---|---|
| | Raw material | [% by wt.] |
| A component | Araldite GY 240 ® | 49.3 |
| B component | Euredur 45 ® | 50.7 |

The resulting adhesive tape had a tensile strength of 73.3 N/cm with an elongation at break of 70.2%. The bond strength on steel was 4.3 N/cm.

A metal test panel was coated electrophoretically with the cathodic electrocoat Cathoguard 400 from BASF and baked at 175° C. for 20 minutes. The adhesive tape was bonded to the test panels without bubbles in a width of 20 mm and a length of 30 cm in the shape of an S curve, and pressed on firmly. The fold-free bonding on the curves required a high level of force to be exerted in order to stretch the film. Subsequently, in accordance with hard practical conditions, the bonded panel was coated with a surfacer, which was baked at 180° C. for 30 minutes. After cooling, a solventborne basecoat film was applied, which was flashed off at room temperature for 5 minutes and then covered with a 2-component clearcoat. The panel was subsequently dried in an oven at 130° C. for 30 minutes.

Visual assessment after cooling showed the tape to be unchanged in position relative to the original position. Subsequently, the tape was removed at various peel angles between 45° and 180°. It was possible to remove the adhesive tape from the cathodically electrocoated panel without problems, with no tearing or delamination. A clean, paint-free track remained on the cathodic electrocoat substrate. The paint remained adhering fully to the reverse of the tape.

### Example 8

In a customary coating process, a 23 μm thick polyester (polyethylene terephthalate) film was coated with an application thickness of approximately 25 μm from a solution with the natural-rubber-based pressure-sensitive adhesive composition specified in Example 1, and on winding was lined with a standard commercial release paper

The polyester film provided with the pressure-sensitive adhesive composition was coated from the nonadhesive side with a degassed, two-component epoxy resin/curing agent composition at a rate of 1 m/min. The application thickness was 120 μm. Curing took place at a tunnel temperature of 120° C.

The epoxy resin/curing agent composition was made up as follows:

| | | Weight fraction |
|---|---|---|
| | Raw material | [% by wt.] |
| A component | Araldite GY 298 ® | 81.8 |
| B component | Euredur 140 ® | 18.2 |

The resulting adhesive tape had a tensile strength of 80.6 N/cm with an elongation at break of 84.8%. The bond strength on steel was 3.5 N/cm.

A metal test panel was coated electrophoretically with the cathodic electrocoat Cathoguard 400 from BASF and baked at 175° C. for 20 minutes. The adhesive tape was bonded to the test panels without bubbles in a width of 20 mm and a length of 30 cm in the shape of an S curve, and pressed on firmly. The fold-free bonding on the curves required a high level of force to be exerted in order to stretch the film. Subsequently, in accordance with hard practical conditions, the bonded panel was coated with a surfacer, which was baked at 180° C. for 30 minutes. After cooling, a solventborne basecoat film was applied, which was flashed off at room temperature for 5 minutes and then covered with a 2-component clearcoat. The panel was subsequently dried in an oven at 130° C. for 30 minutes.

Visual assessment after cooling showed the tape to be unchanged in position relative to the original position. Subsequently, the tape was removed at various peel angles between 45° and 180°. It was possible to remove the adhesive tape from the cathodically electrocoated panel without problems, with no tearing or delamination. A clean, paint-free track remained on the cathodic electrocoat substrate. The paint remained adhering fully to the reverse of the tape.

### Comparative Example 9

A 25 μm thick PET film web was primed with a solution of 2 parts of natural rubber in toluene, mixed beforehand with 1 part of diphenylmethane diisocyanate, and after drying was coated from solution with the natural-rubber-based pressure sensitive adhesive composition specified in Example 1, with an application thickness of about 25 μm.

The resulting adhesive tape had a tensile strength of 47.2 N/cm with an elongation at break of 74.0%. The bond strength on steel was 3.8 N/cm.

A metal test panel was coated electrophoretically with the cathodic electrocoat Cathoguard 400 from BASF and baked at 175° C. for 20 minutes. The adhesive tape was bonded to the test panels without bubbles in a width of 20 mm and a length of 30 cm in the shape of an S curve, and pressed on firmly. The fold-free bonding on the curves required a high level of force to be exerted in order to stretch the film. Subsequently, in accordance with hard practical conditions, the bonded panel was coated with a surfacer, which was baked at 180° C. for 30 minutes. After cooling, a solventborne basecoat film was applied, which was flashed off at room temperature for 5 minutes and then covered with a 2-component clearcoat. The panel was subsequently dried in an oven at 130° C. for 30 minutes.

Visual assessment after cooling showed the tape to be unchanged in position relative to the original position. Subsequently, the tape was removed at various peel angles between 45° and 180°. On removal, the adhesive tape tore in several places, starting from the edge. During removal, the paint partly flaked from the reverse of the tape.

### Comparative Example 10

A 25 μm thick PET film web was primed on both sides with a solution of 2 parts of natural rubber in toluene, mixed beforehand with 1 part of diphenylmethane diisocyanate.

A flexible PVC film of 90 μm in thickness which had been primed beforehand with a nitrile rubber/natural rubber solution was coated with a solution of a natural rubber adhesive composition in petroleum spirit, having a solids content of 30 percent by weight. This consisted of 50 parts of natural rubber, 10 parts of zinc oxide, 3 parts of rosin, 6 parts of alkylphenol resin, 17 parts of terpene-phenolic resin, 12 parts of poly-β-pinene resin and 2 parts of gold oil. The coat thickness was chosen so that drying with heat gave an adhesive film with a thickness of 30 μm.

Immediately after the drying, before the film web was wound up, the primed PET film was introduced and rolled on firmly, without creases, under high pressure between two laminating rolls. When the two films were pulled apart in a tensile testing machine at an angle of 90° and a rate of 300 mm/min, the delamination resistance was found to be 6.2 N/cm.

The already primed PET underside of the laminate was coated from solution with the natural-rubber-based pressure-sensitive adhesive composition specified in Example 1, with an application thickness of about 25 μm.

The resulting adhesive tape had a tensile strength of 71.2 N/cm with an elongation at break of 131.1 %. The bond strength on steel was 3.8 N/cm.

A metal test panel was coated electrophoretically with the cathodic electrocoat Cathoguard 400 from BASF and baked at 175° C. for 20 minutes. The adhesive tape was bonded to the test panels without bubbles in a width of 20 mm and a length of 30 cm in the shape of an S curve, and pressed on firmly. The fold-free bonding on the curves required a high level of force to be exerted in order to stretch the film. Subsequently, in accordance with hard practical conditions, the bonded panel was coated with a surfacer, which was baked at 180° C. for 30 minutes. After cooling, a solventborne basecoat film was applied, which was flashed off at room temperature for 5 minutes and then covered with a 2-component clearcoat. The panel was subsequently dried in an oven at 130° C. for 30 minutes.

Visual assessment after cooling showed the tape to be unchanged in position relative to the original position. Subsequently, the tape was removed at various peel angles between 45® and 180°. On removal, the adhesive tape delaminated from the cathodically electrocoated panel after a few centimeters, for no apparent reason. In one case, a small section of polyester film remained on the panel, without complete delamination. The paint remained adhering fully to the reverse of the tape.

What is claimed is:

1. An adhesive tape provided on one side with a self-adhesive composition and comprising a backing material comprising a polyester film coated with a crosslinked epoxy resin.

2. The adhesive tape as claimed in claim 1, wherein the crosslinked epoxy resin layer is prepared using liquid, solvent-free epoxy resins based on bisphenol A, based on bisphenol F or bisphenol A/F, reactively diluted or plasticized epoxy resins, polyfunctional novolak glycidyl ether resins, aliphatic or cycloaliphatic epoxy resins and mixtures of said epoxy resins.

3. The adhesive tape as claimed in claims 1 and 2, wherein curing agents used for the epoxy resins comprise formulated polyethers/polyamines, nonformulated aliphatic polyamines, araliphatic polyamines, cycloaliphatic polyamines, aromatic amine curing agents, modified polyamines, polyamidoamines, polyaminoimidazoline, polyether amines, formulated adducts and mixtures of said amines.

4. The adhesive tape as claimed in any of claims 1 to 3, wherein the crosslinked epoxy resin comprises fillers, plasticizers and, if desired, auxiliaries and additives as further formulating constituents.

5. The adhesive tape as claimed in any of claims 1 to 4, wherein on the reverse of the crosslinked epoxy resin there is a release coating.

6. The adhesive tape as claimed in at least one of the preceding claims, wherein the self-adhesive composition has the following makeup:

| | |
|---|---|
| ethylene | from 10 to 30, with particular preference from 10 to 15% |
| | by weight |
| vinyl acetate | from 20 to 55, with particular preference from 30 to 35% |
| | by weight |
| acrylic ester | from 30 to 69, with particular preference from 50 to 60% |
| | by weight |
| acrylamide | from 0 to 8, with particular preference 0.5% by weight. |

7. The adhesive tape as claimed in at least one of the preceding claims, wherein the self-adhesive composition has a thickness of from 15 to 40 μm.

8. The use of an adhesive tape as claimed in at least one of the preceding claims for masking window flanges.

9. A process for producing an adhesive tape as claimed in at least one of the preceding claims, which comprises applying the mixed starting components of the epoxy resin during their chemical reaction phase directly on the polyester film.

10. The process as claimed in claim 9, wherein the polyester film is provided with the self-adhesive composition prior to coating with the crosslinked epoxy resin opposite the side to be coated with epoxy resin.
